(19) United States
(12) Patent Application Publication
(10) Pub. No.: US 2002/0066193 A1
(43) Pub. Date: Jun. 6, 2002

(54) Vehicle chassis and body measurement system and method of operation

(76) Inventor: John C. Hodge, Brevard, NC (US)

Correspondence Address: Howard M. Cohn, Suite 110, 23360 Chagrin Blvd., Cleveland, OH, 44122-5537, US

(21) Appl. No.: 09/891,892

(22) Filed: Jun. 26, 2001

Related U.S. Application Data
(60) Provisional application No. 60/251,365, filed on Dec. 5, 2000.

(51) Int. Cl. G01C 15/02; G01B 5/25

(52) U.S. Cl. 33/293; 33/288

(57) ABSTRACT

A vehicle chassis and body measurement system and method of operation thereof is disclosed. The measurement system uses light-reflective targets placed at known offsets from measurement points on a vehicle. The system has a measuring head that directs two beams of light from the head at the light-reflective targets. When the light reflects back from the targets to the head, it is sensed and enables the system to determine the location of the target. The lights in the head are adjusted by the system until the reflected light signal disappears. The system can determine the relative position of the vehicle measurement points using the calculated target location measurements and the manually measured position of the targets.

### CROSS-REFERENCE TO RELATED APPLICATIONS

This application claims the benefit of U.S. Provisional Patent Application No. 60/251,365, filed Dec. 5, 2000 by Hodge.

### FIELD OF THE INVENTION

The invention relates to a chassis and body measurement system for locating a plurality of points on a vehicle and, more particularly, to a computerized system for automatically using laser beams and reflective targets to locate the points.

### DESCRIPTION OF THE PRIOR ART

Chassis and body measurement systems for vehicles collect data regarding the location of points on the vehicle, which can then be compared with manufacturer's specifications. This is important, for example, when repairing accident damage to a vehicle where the chassis may have become deformed as a result of the accident and must be corrected. Various machines are known for correcting deformations, such as frame pullers (pulling fixtures). The present invention is not directed to such machines, but rather to measurement systems which are used in conjunction with such machines.

Prior art chassis and body measurement systems for vehicles have suffered from a variety of drawbacks which have limited their effectiveness. Early measuring systems employed mechanical components such as long bars with measuring tape. Measurements had to be compared to the specifications manually. Mechanical techniques such as these were very cumbersome, difficult to use and very time consuming.

In an attempt to alleviate difficulties associated with such mechanical measuring systems, various automated systems have been developed. Generally speaking, these systems use central computers to control a remote and moving measuring instrument, to gather information and compare readings to specifications stored in memory. Unfortunately, these systems have been difficult to set-up and have been unduly complex and expensive. Also, the use of a central computer for control during measuring limits the distance that the measuring instrument can be from the computer, limits the use of one measuring instrument per computer which increases the investment of a second measuring instrument and increases the time for the complete process since the computer cannot be used for other tasks while measuring.

One type of automated, vehicle measuring system employs sound for location of targets. Unfortunately, the sound can be attenuated, redirected, jammed and changed by other equipment and the environment of the shop. Measurement of upper body points is difficult and inaccurate.

Another type of automated, vehicle measuring system employs an articulating arm to locate points on the vehicle. The arm can be attached to a point during pulling and may even hold some part during repair. Unfortunately, the system must be placed under the vehicle, can measure only a very limited number of points (e.g., only 1), must use a large array of measuring pointers and tips and the measurement of the angle of the arm is inaccurate. Measurement of upper body points is difficult and inaccurate.

Another type of automated, vehicle measuring system employs laser beams, reflective targets and horizontal triangulation methods. The horizontal triangulation methods use either one or two beams which are directed at two different angles to a target. The beams are rotated to move approximately horizontally. The horizontal distance between the beam sources is measured along with the angle of each beam to the target. The advantage of using reflective targets is that there can be many of them measuring several points in a short time. The return light sensor is located such that a relatively high amount of reflected light is required. This requires the target to be reflective and to reflect in many angles to impinge on a sensor. This requires the target to be wide. Unfortunately, this type system has had larger than desired error in measuring, in part because the required angle measurement is very difficult to accurately achieve and is error prone.

The angle measurement error requires the system to be placed close to the points being measured. The greater the distance between the targets and measuring system the greater the error. Some systems are placed under the vehicle which interferes with the pulling operation.

Other systems are placed alongside the vehicle between the pulling fixtures and the vehicle.

The computerized systems which use reflective targets typically require the operator to construct the targets from several pieces according to the specifications. This often requires a large selection of holding fixtures, lengths of rod, etc. Also, doing this adds time to the test duration.

Another limitation of the targets of the other systems is that they are required to hang free to achieve plumb. The measurement systems which use such targets have a limitation that the target can wave (move, as in a breeze) during testing. This breezy condition typically exists in outdoor testing and with an open shop door.

Another limitation of the targets is that they are typically expensive and fragile. If an optical (reflective) target falls off, it may be scratched. If it is scratched, it cannot function properly. Therefore, a new, expensive target must be purchased.

Another limitation of some other systems' targets is that they are wide. This is because the scan required is horizontal. Being wide means that one target has a high probability of obstructing the line of sight to another target. This places limitations on the measuring instrument and/or makes set up difficult.

Prior art computerized systems are typically positioned rather high off the ground.

Therefore, to measure lower chassis points, they must be used with the vehicle on a lift or held higher than normal ride height. Therefore, measurement for estimation requires a lift which many collision shops don't otherwise require or that the vehicle be mounted on a pulling rack. Both options are expensive for the collision repair shop.

An initial step in target placement is to identify which points on the vehicle are undamaged “reference” points before measuring is done. Some computerized systems attempt to match the points measured with the specification by use of “best fit” mathematical schemes of all points or of only the reference points. If the chosen points are damaged or even slightly out of position or if undetected damage is present, this type of measurement analysis presents a false picture of the true condition of the vehicle. In some cases the operator must choose different reference points, reposition the targets and start again. These schemes also have difficulty handling asymmetrical points.

In view of the difficulties associated with prior measuring systems, there remains a need for an optical measuring system employing the favorable features of a light beam, without the drawbacks discussed hereinabove. Additionally, it is desirable to have a vehicle measuring system that will provide more accurate and consistent readings. It is desirable to have a measuring system that can be set out of the way to allow operators under the vehicle and that can be used during the pulling process. It is desirable to have a measuring system that can measure when the vehicle is at the normal ride height. Additionally, it is desirable to have targets which will remain in position, even when measuring is being performed in a slight breeze.

Attention is directed to the following US Patents, incorporated in their entirety by reference herein: U.S. Pat. Nos. 4,830,489; 4,788,441; 5,029,397; 5,207,002; 5,251,013; 5,721,618. More particularly:

U.S. Pat. No. 5,721,618 discloses apparatus for measuring the dimensions of a large object with the aid of a narrow optical measuring beam directed onto a number of measuring points. A hit indicator unit is placed in connection with each measuring point. The apparatus includes rail which can be placed adjacent the object to measured and which carries a measuring carriage which is movable along the rail and which directs the direct the narrow optical measuring beam at an angle relative to the measuring path in an object reference plane. The carriage is moved rectilinearly along the rail. Each hit indicator unit coacts with an indicating arrangement which automatically indicates a hit by measuring beam. The carriage is provided with an automatically indicating rail-position sensor and the indications given by the sensor are read-off with each automatic hit indication through the medium of the indicating arrangement.

U.S. Pat. No. 5,251,013 discloses apparatus and methods for determining the deformation of a vehicle body comprising coded targets including coded reflective surfaces positioned in predetermined locations relative to the vehicle body for indicating deformation of the body by determining the spatial position of the targets, a laser generating unit positioned for sweeping a laser beam across the reflective surfaces of the targets, a receiver for receiving the reflected beam, and computer-based, electronic equipment and logic responsive to the receiver for indicating the spatial position of the target means relative to a predetermined normal position with respect to the vehicle body. Apparatus also for determining two and three dimensional spatial coordinates of objects from each other and from a base, utilizing the foregoing components. Additional apparatus comprising portions of the foregoing.

U.S. Pat. No. 5,207,002 discloses a method and system for use in the checking and/or correction of alignment of a vehicle frame, body and various parts thereof which utilize an energy beam generator to direct one or more beams, such as a laser beam, at multiple targets which may be mounted on the vehicle frame, body or specific parts thereof, to establish a horizontal reference centerline and a vertical reference datum line from and/or to which alignment measurements may be made. Such method and system are enhanced by the use of either a unidirectional or sweeping beam to establish a centerline and a sweeping beam to establish a datum line. The beam generating means and targets preferably are located within the confines of a vehicle frame or body with the centerline defining beam and target being centered between undamaged portions of the same vehicle parts from which or to which measurements are to be made.

U.S. Pat. No. 5,029,397 discloses a method of measuring a vehicular frame to determine alignment, where measurements provided in the manufacturer's specifications are known. The method consists of the following steps. Firstly, establishing at least one reference point spaced from a vehicular frame. Secondly, triangulating the vehicular frame by measuring the angle from the reference point to one or more coordinate points provided in the manufacturer's specifications. One side of the triangle containing the reference points is a reference line of a known length. Thirdly, using the length of the reference line and the angular measurement from the reference points as a basis for trigonometric calculation.

U.S. Pat. No. 4,830,489 discloses a laser beam alignment system which includes a transmitter which establishes a laser reference plane by continuously rotating a horizontal laser beam about the transmitter. A remotely located receiver senses the elevation of the laser reference plane and reflects a portion of the laser energy back to the transmitter where the reflected energy is employed to produce a signal indicative of the range of the receiver and its location with respect to a reference axis. The position of the receiver is thus established in three dimensions.

U.S. Pat. No. 4,788,441 discloses a target which has leading and trailing edges which are boundaries between a retroreflector and a non-retroreflector. The target is used in target determining apparatus for distance, width, azimuth, gauging, profiling, object detection, and particular target identification. A laser light source scans along a scanning path across the target. The retroreflector reflects light back toward the scanning means where it is received in a photoreceptor to determine the angles of the target edges. The distance to the target and the width are inversely proportional to the length of time that the light beam scans across the target. The laser light also scans across a reference point and the length of time between this reference point and the reflection from the target is directly proportional to the azimuthal position of the target relative to the reference. Further, the target may include a plurality of reflective and non-reflective strips transverse to the scanning path to establish binary indicia on the target. This results in a series of pulses from the photoreceptor as the beam scans the width of the target. This information is then decoded to determine the binary indicia and hence identify that particular target.

### SUMMARY OF THE INVENTION

A general object of the invention is to provide an improved measuring system for vehicles, one which overcomes the difficulties of prior art systems stated hereinabove.

According to the invention, a measuring system uses multiple targets, a head and a computer. According to the broad aspect of the invention, targets which may be placed on the ground identify the points to be measured. The points being measured on the vehicle are termed “measuring” or “measurement” points. Selected ones of the points the vehicle are termed “reference” points.

Two, highly collimated beams of light such as lasers from a head provide two straight lines. These beam sources are a fixed and known distance apart and have a fixed and known angle relative to each other. The structure (platform) holding the beam sources rotates. The angle of rotation of the holding structure is measured as each beam strikes a target. From these two angular measurements, the angle and distance to each target can be calculated. The height of the target is measured by rotating each beam down the target from horizontal to the bottom of the target. This is done by tilting the platform upon which the lasers are mounted. The angle from horizontal to the bottom of the target, the known dimensions of the target and user-provided information about the target is used to calculate the height of the measurement point.

An external computer can be used to provide greater display capability. This system is compact, relatively inexpensive, portable, accurate, easy to use and can be set up for measurement purposes in a minimal time.

According to a feature of the invention, a target comprises a holding device, a means for measuring from the holding device to the bottom of the target, an optional plumb indicator, a reflective surface and an optional means for holding the target stationary in a breeze. The targets are relatively thin (narrow) so that the target is less susceptible to a breeze and is less of an obstacle (line-of-sight obstruction) to other targets. Thus, set up is easier. The comparative minimal requirements on the target allow it to be constructed inexpensively and hard. Therefore, when it is dropped, it won't be destroyed because of a scratch. Also, the minimal number of different parts necessary for the operator to make a target allows the target attachment process to be done very quickly.

Disposed within the head are the rotation module, the left and right laser sensor module, the height measuring module, the leveling module and the electronics module.

The targets are placed on the points to be measured by first placing the bottom of the target on or close to the surface supporting the vehicle to be measured. Next, the extensions are extended until the holding device is in the hole or on the surface of the point to be measured. The target is made plumb with the aid of the plumb indicator. Lastly, the operator notes the values of the extensions used.

The head is placed on the surface supporting the vehicle to be measured. The surface should be level enough so the head may level itself, for example, within about 3 degrees of level. The surface must allow the light beams from the head to impinge on all targets.

Because the construction of the fixed, two-beam arrangement is low, the head may be place under the vehicle while the vehicle is supported by its own suspension system. The vehicle to be measured may be supported on its wheels, on a lift or on a pulling bench. The head may be placed on either side, in front of, in back of or under the vehicle to be measured. Therefore, estimates are much easier to do because they may be done in parking lots, or on the floor of a garage.

A computer with a transmission unit attached by cable is positioned such that the computer and the head may send signals to each other, preferably without a hard-wire connection therebetween (i.e., wirelessly). Signals from the computer cause the microprocessor control unit in the head to begin measuring. The rotating unit of the head will then revolve and take measurements.

While the head is gathering data, the operator may enter the necessary customer and file information into the computer.

When both the head and operator are ready, the operator causes the computer to send a signal to the head which will cause to head to transmit the gathered data. After the data is transmitted, the computer will display an interim screen showing the position of the measured points relative to the head. The operator then enters the target data he noted for each target. The operator is now ready for the analysis which will compare the measured and specification data to decide on a course of action.

The system doesn't require the points to be predetermined, the head simply measures the targets it detects.

The microprocessor in the head allows the head to perform all the functions necessary to locate the points of the vehicle. The external computer is used to provide greater display and user interface capability. Also, by placing the calculating and control function in the moving head, the measurement process can be done outside the range of the communications link to the computer. This allows the system to be cordless, allows the computer greater versatility in its use and placement.

One of the advantages of having a microprocessor in the head is that the head can independently perform the measurement process (“off-line”) while the operator uses the computer for other purposes. Such “other purposes” could include managing the operation of yet another measurement head, to allow data searches and printouts of other jobs, and to do administrative tasks.

Because of the construction of the targets, targets may be placed on the vehicle without first constructing them in a predetermined configuration. Therefore, a large array of parts of targets is unnecessary and the data of the configuration of the target on each point can be entered into the computer when the head is doing the measuring. This saves considerable time in making the requisite measurements.

The method of measuring the data provides three data points per target. These data points are mathematically orthogonal. Therefore, another coordinate system can be calculated such as a rectangular grid coordinate system with its center and orientation similar to that shown in specification data sheets. Compared to mechanical measuring systems, this system allows easier analysis of the vehicle.

The method of measuring the data to achieve height and distance of the targets is much more accurate than other ranging methods. Generally, ranging requires two angles and a (baseline) distance connecting the two angles. In other automated systems, the angle measurement is difficult and error prone partly because the range of sweep motion is large. In the present invention, one of the angles is vertical (plumb to gravity) which is easily and accurately achieved. Since the distance between the angles needed is fixed, it can be established very accurately during manufacture. The direction from the head angle requires relatively wider tolerance and is easily measured. The other angle is the difference in angle when each beam impinges on the target. A relatively tight tolerance is needed for this angle. In a preferred embodiment, electronic differentiation of the beams is provided by having the light beams oscillate at different frequencies. Therefore, the beams can both be in the same field of view of each sensor. By having the two beams directed such that they intersect, the farther the target, the closer the beams and the more accurate the measurement.

Greater accuracy in angle measurement allows a greater distance between the targets and the measuring device. This allows this invention to be placed at the end of the vehicle and out of the way. Therefore, re-setup after pulling is unnecessary.

While the head is gathering data the operator can enter administrative data such as owner information or may use the computer for other tasks including controlling another head.

The measured data and specification data are then preferably displayed together. The operator chooses reference points. The computer displays the measured data and specification data again with the chosen points overlaid as closely as possible. The remaining measured data points are displayed relative to the measured chosen points and the remaining specification data points are displayed relative to the specification chosen points. Therefore, each type of data is in its own coordinate system. Testing alternate views is, therefore, easily done. The operator has the choice of choosing other reference points, moving or rotating the measured data coordinate system relative to the specification data coordinate system or of moving the center of the coordinate system used to display the measured data. Since no physical changes are necessary, this allows the operator maximum versatility and ease of analysis. Asymmetrical points are easily handled. A correct picture of the vehicle can be obtained even with reference points slightly out of position. Minor damage can be easily detected rather than distorting the overall picture.

By using the measuring system according to the invention, set-up time is reduced and the system may be used while pulling. Compared with prior automated measuring systems, the measuring system according to the invention is accurate, mechanically and electrically straightforward, inexpensive and reliable.

According to the invention. a method of measuring a plurality of points on a vehicle comprises: disposing a plurality of light-reflective targets at a plurality of points on the vehicle; with a measuring head, directing light beams at the targets and sensing light reflected from the targets; determining positions of the targets based on the angle of the head when each of the plurality of light beams is reflected from the target; and with the measuring head, sensing a black-white-black pattern from a narrow reflector surface to pick out a target.

Further properties and advantages and a more complete understanding of the invention will become apparent by referring to the following descriptions and claims, taken in conjunction with the accompanying drawings.

### DESCRIPTION OF THE DRAWINGS

Reference will be made in detail to preferred embodiments of the invention, examples of which may be illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the figures may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

The structure, operation, and advantages of the present preferred embodiment of the invention will become further apparent upon consideration of the following description taken in conjunction with the accompanying figures, wherein:

FIG. 1 is a view, partially in perspective, of the system layout as it would be set up to measure from under the vehicle on the ground, according to the invention;

FIG. 2 is a view, partially in perspective, of the system layout as it would be set up to measure from the rear of a vehicle on the ground, according to the invention;

FIG. 3 is a perspective view of the upper body target, according to the invention;

FIG. 4 is a top and front perspective view of a head, according to the invention;

FIG. 5 is a top view of the head with the housing removed, according to the invention;

FIG. 6 is a view of the head with the housing removed, taken on the line 6-6 in FIG. 5, according to the invention;

FIG. 7 is a view of the head with the housing removed, taken on the line 7-7 in FIG. 5, according to the invention;

FIG. 8 is a view of a component of the head, taken on the line 8-8 in FIG. 5, according to the invention;

FIG. 9 is a view of a component of the head, taken on the line 9-9 in FIG. 5, according to the invention;

FIG. 10 is a bottom and back perspective view of a head, according to the invention;

FIG. 11 is a cross section of a hanging target, according to the invention;

FIG. 12 is a cross section of a ground support target, according to the invention;

FIG. 13 is general simplified block diagram of the electronic circuit arrangement in the head, according to the invention;

FIG. 14 is a top schematic view of the beam and target and scattered light relationship when the beam first impinges on a target, according to the invention;

FIG. 15 is a top schematic view of the horizontal angular relationship of the target and beam when the light sensors first detect a white area and when the light sensors detect the white to black transition, according to the invention;

FIG. 16 is a top schematic view of the horizontal and angular relationships of the head lasers, axis of rotation and two targets when the first laser beam first detects a target, according to the invention;

FIG. 17 is a top schematic view of the horizontal and angular relationships of the head lasers, axis of rotation and two targets when the second laser beam detects the trailing edge of the second target, according to the invention;

FIG. 18 is a top schematic view of the horizontal and angular relationships of a target, both beams and the horizontal axis of rotation, according to the invention;

FIG. 19 is a side schematic view of the relationship of the measured vertical distance, the height of the target and the distance between target and axis of horizontal rotation, according to the invention; and

FIG. 20 is a left side schematic view of a magnetic attachment device in a hole.

### DETAILED DESCRIPTION OF THE INVENTION

The Overall Measuring System

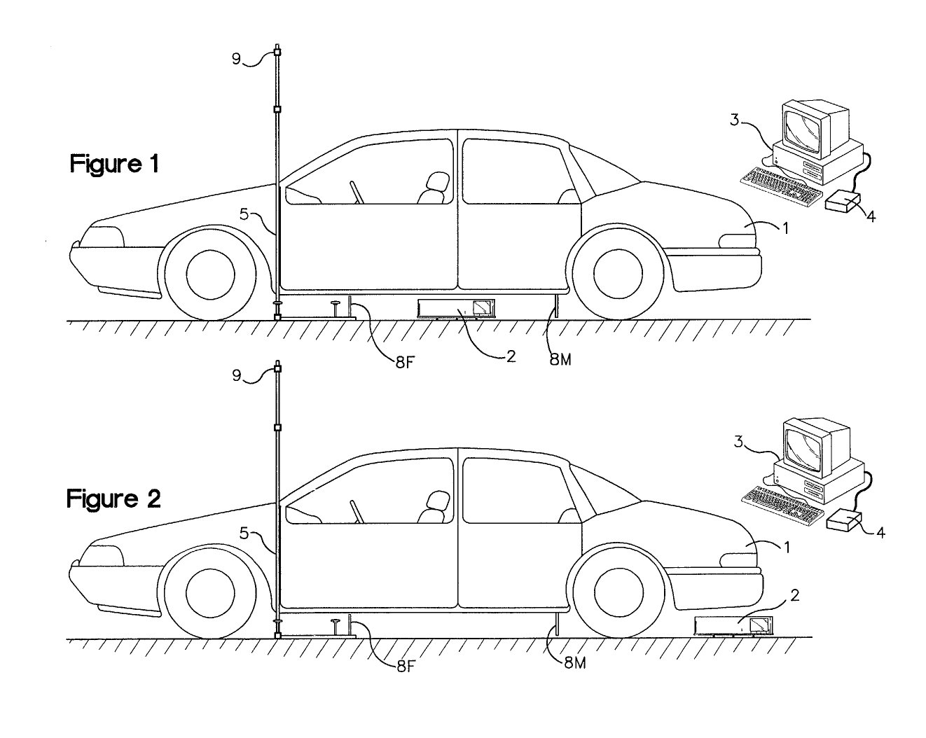

FIGS. 1 and 2 illustrate a vehicle chassis and body measurement system, according to the present invention, as it would be set up to measure points on a vehicle-under-test 1 which is resting (supported) on a support surface. In this case, the support surface is the ground. The support surface could as well be a rack (not shown) or a pulling bench (not shown).

The vehicle chassis and body measurement system generally comprises a measuring head 2, a plurality of reflective targets 8 (as discussed below), and a computer 3. The measuring head 2 has two lasers and corresponding two light sensors, and can determine the locations of the plurality of targets 8. As described in greater detail hereinbelow, data accumulated by the head 2 is transmitted to the external computer 3. A transmission module 4 is attached to the computer 3 for communicating with the head 2. The computer 3 provides the operator with analyzed data, display and printout capability and control of the head 2.

As used herein, a target is generally referred to by the reference numeral “8”. Specific types of targets may be referred to with the numeral “8”, followed by a one or two letter suffix, for example target 8M above a point M, target 8FR at the front (FR) of the vehicle, target 8HA for a hanging target, or target 8GS for a ground support target.

As shown in FIG. 1, the head 2 is placed under the vehicle-under-test 1, on the same support surface as the vehicle-under-test 1 is resting upon. The vehicle-under-test 1 is provided with multiple targets 8 which mark the location of points to be measured and which the head 2 can detect by means of the impingement of a light beam. In a preferred embodiment, the light beam is a laser.

As shown in FIG. 2, the head 2 is placed under the rear of the vehicle-under-test 1, on the same support surface as the vehicle-under-test is resting upon.

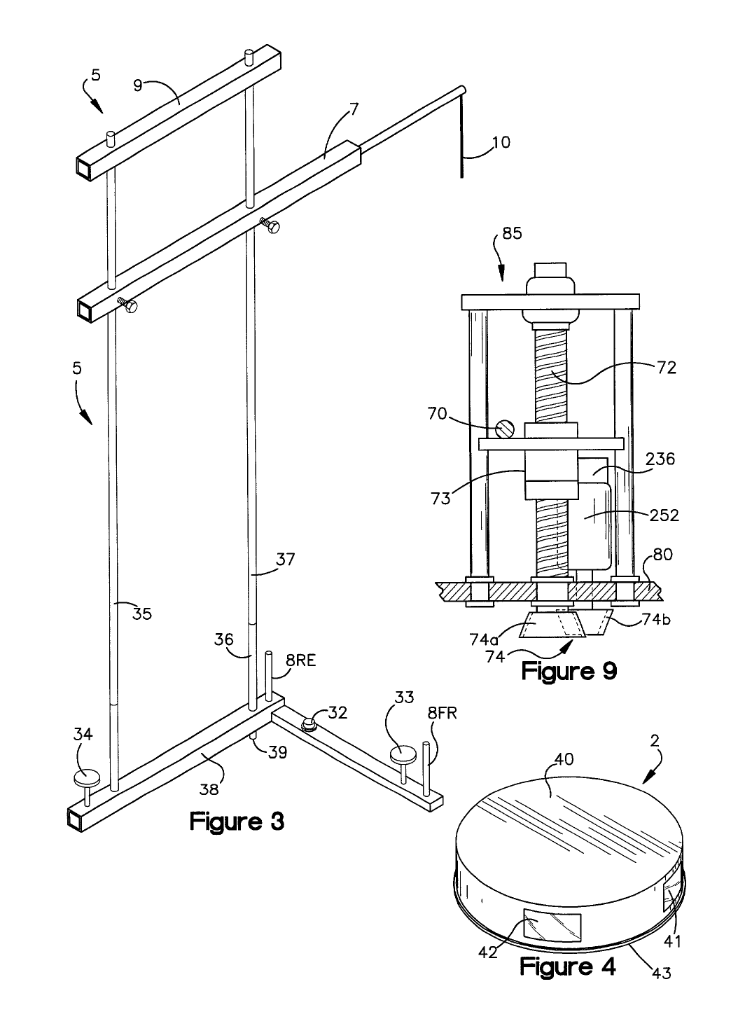

FIG. 3 illustrates the upper body measuring fixture 5 for measuring upper body points. As best viewed in FIGS. 1, 2 and 3, the upper body measuring fixture 5 rests on the ground on a upper fixture support (or base) 38 which has the front level adjustment 33, rear level adjustment 34 and on a fixed support 39 on the ground. Fixedly attached to the upper fixture support 38 is a upper fixture level 32. The front level adjustment 33 and rear level adjustment 34 are adjusted until the upper fixture level 32 indicates the upper measuring fixture 5 is level. Also attached to the upper fixture support 38 are a front target 8FR and a rear target 8RE which are mounted vertically to the upper fixture support 38 and at either end of one of the legs of the upper fixture support 38. The front target 8FR and rear target 8RE are metal tubes with the reflective surface, size and diameter of other target 8 used in measuring. The front target 8FR in a preferred embodiment is mounted on the upper fixture support 38 slightly lower than the rear target 8RE. The upper fixture support 38 is black or reflects little light. Also attached and mounted vertically to the upper fixture support 38 are the rear guide bar 35 and front guide bar 36. In a preferred embodiment, the rear guide bar 35 and front guide bar 36 are solid, steel rods, a half inch in diameter and extend about 6 feet vertically. The stabilizing bar 9 is fixedly attached to the top of the rear guide bar 35 and front guide bar 36 to maintain a constant distance and orientation between the rear guide bar 35 and front guide bar 36. The rear guide bar 35 and front guide bar 36 must hold the upper fixture bar 7 and pointer 10 in a fixed orientation and position relative to the front target 8FR and rear target 8RE. The front guide bar 36 has an upper tape measure 37 to measure the height of the upper fixture bar 7 and pointer 6. The pointer 6 is positioned on the upper point to be measured. The upper fixture bar 7 and pointer 6 are bolted to the rear guide bar 35 and front guide bar 36 to hold position while measuring. The relative position of the end of the pointer on upper fixture bar 7 and pointer 6 and of the front target 8FR and rear target 8RE is calibrated by a procedure before use. Thus, the position of the upper fixture bar 7 and pointer 10 can be calculated if the position of the rear target 8RE, the front target 8FR, and the height along the upper tape measure 37 are known.

Targets

FIG. 11 illustrates one type of target 8, a hanging target 8HA. A preferred embodiment has the attachment to the measurement point being a hanging disc magnet 11. Other attachments are possible such as hooks and clamps. The radius of the disc of the hanging disc magnet 11 is large enough to rest on the shoulders of the hole of a measurement point. Also, the hanging disc magnet 11, being magnetic, will attract to the metal of bolts for those measurement points which are bolts.

The spacer rod 13 of target 8HA is of adjustable length (or there are spacer rods of various lengths) to accommodate the differing height of measurement points. These lengths are fixed and known. The hanging disc magnet 11 attaches to the spacer rod 13 by the hanging rod connector 12. The spacer rod 13 is attached to a hanging elongated cylindrical element 16 by a threaded rod insert 14 which is fixedly attached to the hanging element 16.

The hanging element 16 can be a solid rod or a hollow tube. In a preferred embodiment, the hanging element 16 is narrow tube, such as a half inch in diameter, and is made of aluminum. The length of the tube is approximately two inches. The surface of the hanging tube 16 is covered by a white paint 17 or has similar reflectivity so as to reflect impinging light sufficient to be detected by sensors. The tube 16 has a rounded external surface (a cylindrical tube is but an example of a structure exhibiting such a rounded external surface).

The hanging disc magnet 11, when resting and attracted to the metal of the measurement point, has a resistance to movement caused by friction. This resistance prevents the hanging target 8HA from being moved by breezes and other slight disturbances. The hanging plumb line 18 is to ensure that the hanging target 8HA hangs plumb. The hanging plumb line 18 is held in the center of the hanging tube 16 by the plumb insert 15 which is fixedly attached to the hanging tube 16. The operator will move the hanging target 8HA while the hanging disc magnet 11 is attached to the measurement point such that the hanging plumb line 18 hangs plumb and centered in the hanging cylindrical element 16. Other plumb indication devices may be used such as bubble levels, other types of pendulums or plumbs.

FIG. 12 illustrates another type of target, a ground support target 8GS. The main support of the ground support target 8GS is the ground unlike the hanging target 8HA and others. The foot (or base) 31 rests on the ground and is to be placed under the point to be measured. The foot rod (or support) 27 is rotatably retained in the foot 31. The foot rod 27 extends through the center of the foot insert 26. The friction between the foot rod 27 and foot insert 26 is such that the remainder of the ground support target 8GS can be supported. The foot insert 26 is centered and fixedly attached to the ground tube 28. Like the hanging tube 16, the ground tube 28 is a hollow metal tube and has a surface coating ground white surface 29. A foot pin 30 is placed in the end of the foot rod 27 to retain the foot rod 27 in the foot insert 26. The foot 31 and foot rod 27 are painted black so as to reflect little impinging light. The plumb attachment 24 is fixedly attached to the top of the ground tube 28. The plumb attachment 24 holds the ground plumb line 25 at a fixed distance from the ground tube 28. Other plumb indication devices may be used such as bubble levels, other types of pendulums or plumbs. The extendible tube 21 is hollow and fits inside the ground tube 28. The extendible stop 23 is fixedly attached to the extendible tube 21 and is snug against the inside wall of the ground tube 28. The stop ring 22 is fixedly attached to the inside wall of the ground tube 28. The extendible tube 21 is snug against the stop ring 22 and can slip in the ground tube 28 but not flex sideways to the ground tube 28. The extendible tube 21 and ground tube 28 are coaxially aligned. The extendible tube 21 has a length gradation such as a ruler attached to indicate the distance the extendible tube 21 is pulled out of the ground tube 28. The ground support disc magnet 20 is fixedly attached to the top of the extendible tube 21. In a preferred embodiment, the ground support disc magnet 20 is, like the hanging disc magnet 11, disc shaped, magnetic, and large enough to fit snugly in the largest hole to be measured. The extendible tube 21 could be non-magnetic, a pointer or cone shaped. The ground support disc magnet 20 is not required to attach to the point to be measured, merely to indicate the point's position. As such, the ground support target 8GS could be used on aluminum frames.

In using the ground support target 8GS, the ground support target will be adjusted such that the ground support disc magnet 20 is at the point to be measured, the ground support target 8GS is resting on the foot 31, and the ground plumb line 25 is plumb and equidistant from the ground tube 28 along its length. This latter relationship ensures that the ground support target 8GS is plumb.

There have thus been described a number of targets 8, each of which is thin/narrow, has a rounded external surface, and is light reflective. Further, each of the targets 8 has a way of being disposed at a location which can be measured and which is offset by a known distance and direction from an associated point on the vehicle-being-tested.

In this manner, the plurality of light-reflective targets 8 can be disposed at known locations (offsets) with respect to a corresponding plurality of vehicle measurement points, including points which are below the vehicle, as well as points which are on the exterior, including the upper exterior surfaces of the vehicle. Then, the locations of the targets, hence of the vehicle measurement points, can be measured. As will become evident from the description that follows, the fact that the outer reflective surfaces of the targets (8) are cylindrical (rounded) is an important feature of the invention. It is also preferred that each of the targets is maintained in a plumb position, with the axes of the cylindrical tubes all being vertical. It is also within the terms of the present invention to provide a target with a black-white-black pattern formed on a narrow reflector surface.

Measuring Head

The measuring head 2 is shown, in various views and levels of detail, in FIGS. 1, 2, and 4-10.

FIG. 4 illustrates the outer, front, top of the head 2. The base 43 supports all structures of the head 2. The housing 40 is the cover and side of the head 2. The housing 40 can rotate relative to the base 43. The head 2 has a cylinder shape and is circular in the horizontal plane. The accuracy of the distance measurement improves with larger diameter. However, the diameter must be small enough to be inside all the targets 8 that will be placed on the vehicle-under-test 1. The height of the head 2 should be such that it can comfortably fit under the vehicle-under-test 1 when the latter is resting on its suspension. In a preferred embodiment, the diameter of the head 2 is 24 inches and the height is 4 inches.

The front of the head 2 has the left window 41 and right window 42 in the housing 40. The left window 41 and right window 42 are transparent to the light used.

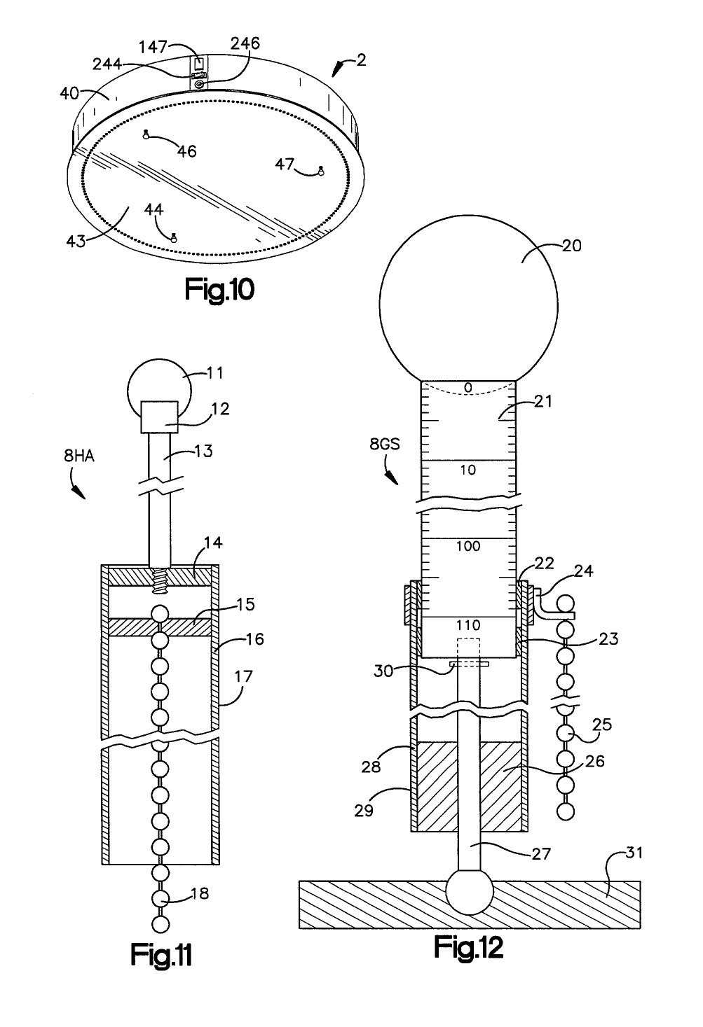

FIG. 10 shows the outer, back, and bottom of the housing 40 of head 2. The on/off switch 244 and power connector 246 are fixedly attached to the back of the housing 40 and disposed for easy operator access when the head 2 is under the vehicle-under-test (1). The transmission window 147 is a type of material that is transparent to the light used in communication. In use, the head 2 will rest on the stationary leg 44, the left leg 46 and the right leg 47. The stationary leg 44 is fixedly attached to the base 43 near the center of the base such that most of the weight of the head 2 will be on the stationary leg 44. The left leg 46 and the right leg 47 are located close to the outside rim of the base 43 and can be adjusted vertically. A line drawn between the stationary leg 44 and left leg 46 and another line drawn between stationary leg 44 and right leg 47 form a right angle.

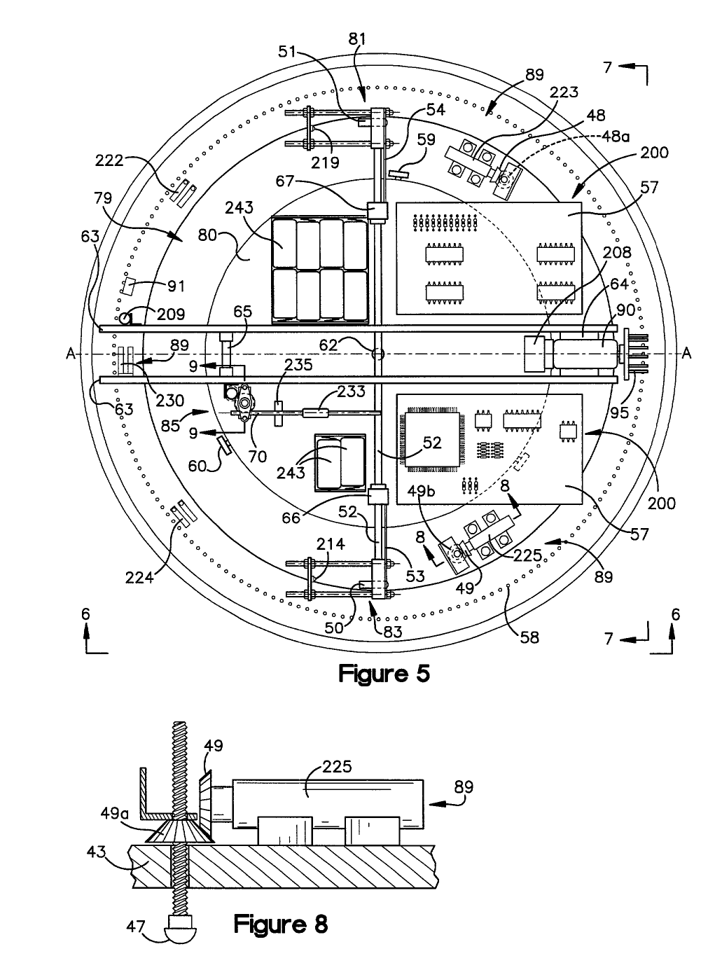

FIGS. 5, 6 and 7 are views of the head 2 with the housing 40 removed so that the disposition of the internal parts can be seen. Disposed within the head 2 are the rotation module 79, the left and right laser sensor modules 81 and 83, respectively, the height measuring module 85, the leveling module 89 and the electronics module 93.

The Rotation Module

The rotation module 79 comprises a rotating platform 80 rotatably attached at the center of the base 40 at a pivot point 62. The pivot point 62 is suitably a roller bearing with a post fixedly attached to the base 43. The rotating platform 80 is suspended on a first roller 59, a second roller 60 and a third roller 61 which are roller bearings fixedly attached to the rotating platform 80 so that the rotating platform 80 may rotate on the base 43. A front post 64 and a rear post 65 are fixedly attached to the rotating platform 80. A housing support 63 is fixedly attached to the front post 64 and rear post 65. The housing 40 is fixedly attached to the housing support 63. A rotating drive motor 90 is fixedly attached to the housing support 63 and disposed so the front teeth 95 of the rotating drive motor 90 engages the circle of pins 58. As the rotating drive motor 90 runs, the teeth 95 rotate and engage the circle of pins 58 and which causes the rotating platform 80 to rotate. Fixedly attached to the rotating drive motor 90 is the rotation encoder 208. As the shaft of the rotating drive motor 90 turns, the rotation encoder 208 will produce pulses on wires (not shown). The number of pulses are the analog of the amount of rotation of the drive motor 90 and, therefore, of the amount of rotation of rotating platform 80.

A rotating interrupter plate 91 is fixedly attached to the circle of pins 58 at an arbitrary point on the circle of pins 58. This establishes the zero point of the rotation of the rotating platform 80. On the end of the housing support 63, opposite of the rotating drive motor 90, is the one cycle interrupter 209. The one cycle interrupter 209 is so arranged that as the rotating platform 80 turns, it will allow the rotating interrupter plate 91 to pass between the towers of the one cycle interrupter 209 once every complete revolution of the rotating platform 80.

Left And Right Laser Sensor Modules

Referring to FIG. 5, left and right laser sensor modules 81 and 83, respectively, are described. A left axle post 67 and a right axle post 66 are fixedly attached to the rotating platform 80 at a point near the outer edge of the rotating platform. The height of the left axle post 67 and right axle post 66 are such as to provide support to the housing 40. A short height above the rotating platform 80 and extending through the right axle post 66 and left axle post 67 is the laser axle 52. The laser axle 52 extends through bearings which are in the right axle post 66 and left axle post 67 so the laser axle 52 can rotate. When viewed from above, as in FIG. 5, the laser axle 52 is approximately perpendicular to the housing support 63 and slightly forward (to the right as shown) of the pivot 62. The left sensor module 81 includes left laser 51, left light sensor 219 and left lens 54, all of which are fixedly attached to the left end of the laser axle 52. The right sensor module 83 includes right laser 50, right light sensor 214 and right lens 53, all of which are fixedly attached to the right end of the laser axle 52. The optical center of the left lens 54 is placed near the front, center of the left laser 51. The plane of the left lens 54 is perpendicular to the left laser 51. The left light sensor 219 is placed at the focal point of the left lens 54 and is coaxial with the left laser 51. Referring again to FIGS. 4 and 5, the arrangement on the left side of the head 2, the left window 41, left laser 51, left lens 54 and left light sensor 219 is so that when the beam from the left laser 51 impinges on an object, the reflected light back to the head 2 will pass through the left window 41 and be focused onto the left light sensor 219. A similar arrangement is on the right side of the head 2 with the right window 42, right laser 50, right lens 53 and right light sensor 214. That is, when the beam from the right laser 50 impinges on an object, the reflected light back to the head 2 will pass through the right window 42 and be focused onto the right light sensor 214. Moreover, the right laser 50 and left laser 51 are oriented such that the beams from the right and left laser intersect at a point which is at a fixed and known distance from the head 2—preferably at about 16 feet from the head.

Height Measuring Module

As best viewed in FIGS. 5, 6 and 9, the height measuring module 85 includes a level arm 70 with one end fixedly attached to the laser axle 52 so as to extend perpendicular thereto. A height screw 72 is attached near edge of the rotating platform 80 in a position so the rear end of the level arm 70 may engage a nut 73 on the height screw 72. FIG. 9 illustrates, in greater detail, the height measuring mechanism 85 including a height motor 252, the height encoder 236, the height screw 72, the nut 73, the height gears 74, and the end of the level arm 70. The height screw 72 is held by bearings in a vertical direction to the rotating platform 80. On the lower end of the height screw 72 is a gear 74a that is engaged with the gear 74b of the height motor 252. When the height motor 252 runs, the rear end on the level arm 70 will raise or lower and thereby rotate the laser axle 52. The height encoder 236 is fixedly attached to the height motor 252. The height encoder 236 provides pulses to a wire (not shown) connected to the height counter 237. The number of pulses from the height encoder 236 is the analog of the rotation of the level arm 70.

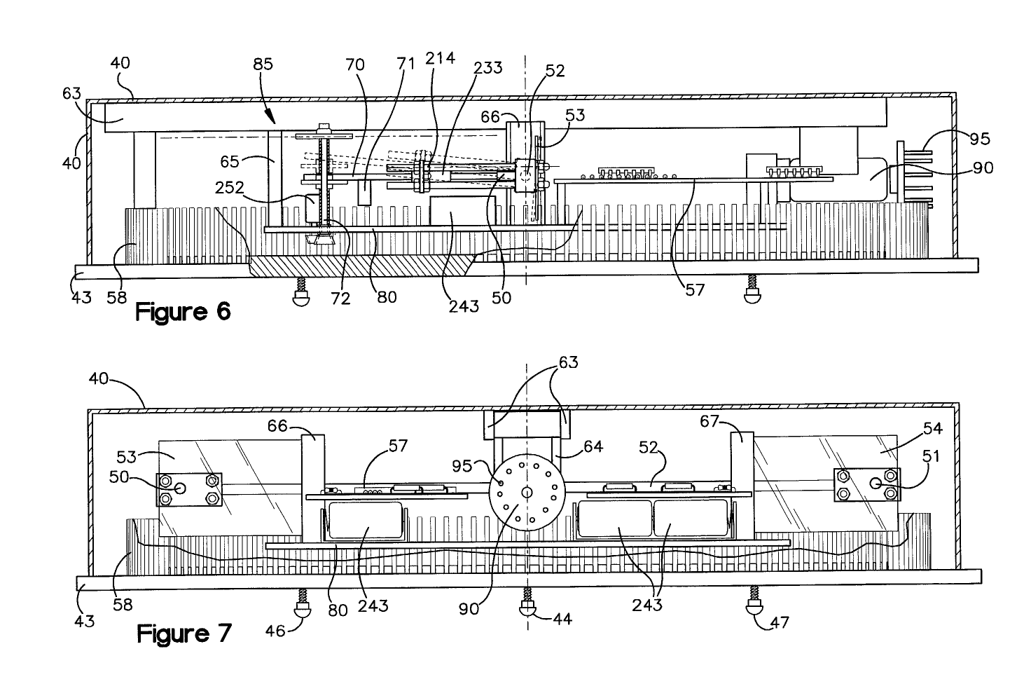

As shown in FIGS. 5 and 6, a level sensor 233 is fixedly attached to the level arm 70 in an orientation such that it will measure when the level arm 70 is level. The level sensor 233 outputs two values of resistance. The difference in the two values of resistance is the analog of the amount of rotation of the level arm 70. The factory calibration is such that when the value of resistance between the wires (not shown) of the level sensor 233 are equal, the level arm 70 is level to gravity and perpendicular to the height screw 72. Also, the beams from the right laser 50 and left laser 51 are perpendicular to the height screw 72. The level interrupter plate 71 is fixedly attached to the level arm 70. A level opto interrupter 235 is fixedly attached to the rotating platform 80 in such a position and orientation that the level interrupter plate 71 will interrupt the light between the towers of the level opto interrupter 235 when the level arm 70 is level. Hence, a high voltage on the wires (not shown) of the level opto interrupter 235 implies the level interrupter plate 71 is clear of the level opto interrupter 235 whereas a low voltage on the wires (not shown) of the level opto interrupter 235 implies the level interrupter plate 71 is between the towers.

Leveling Module

As shown in FIGS. 5 and 8, the leveling module 89 for adjusting the height of left leg 46 and right leg 47 includes a left level motor 223 and right level motor 225 that are both fixedly attached to the base 43. The gears 48 and 49, respectively, of the left and right level motors 223, 225 engage a gear 48a, 49a, respectively, on the right leg 47 and left leg 46, respectively. When the left level motor 223 or right level motor 225 is turned on, i.e. provided with voltage, they will turn unless the left leg 46 or right leg 47, respectively, is at a physical limit. As the left level motor 223 turns, the left leg 46 will extend outward or retract inward and cause the head 2 to rotate about an axis formed between the stationary leg 44 and right leg 47. As the right level motor 225 turns, the right leg 47 will extend or retract and thereby cause the head 2 to rotate about an axis formed between the stationary leg 44 and left leg 46.

The main level brush 230 (see FIG. 5), is fixedly attached to the housing support 63 in such a position that it will engage the left brush 222 and right brush 224 as the rotating platform 80 rotates. The left brush 222 is fixedly attached to the base 43 in such a position that when the main level brush 230 and left brush 222 are in electrical contact, the level arm 70 and hence the level sensor 233 will be perpendicular to the axis of rotation caused by the left level motor 223. The right brush 224 is fixedly attached to the base 43 in such a position that when the main level brush 230 and right brush 224 are in electrical contact, the level arm 70 and, hence, the level sensor 233 will be perpendicular to the axis of rotation caused by the right level motor 225.

Electronics Module

The electronics module 200, as shown in FIGS. 1, 2, 5-7, and 13 comprises the circuit board 57, wall plug 240, transformer 241, power connector 246, batteries 243, on/off switch 244, right laser 50, left laser 51, main level brush 230, left brush 222, left level motor 223, right brush 224, right level motor 225, right light sensor 214, left light sensor 219, computer 3, transmission module 4, transmitter/receiver 204, one cycle interrupter 209, rotation encoder 208, level sensor 233, height motor 252, level opto interrupter 235, height encoder 236 and rotating drive motor 90.

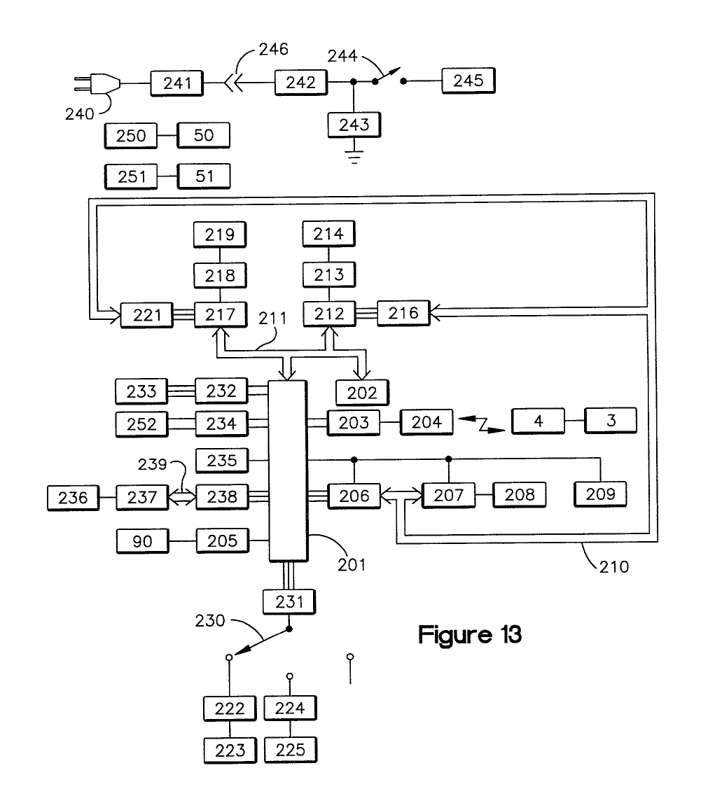

FIG. 13 is general simplified block diagram of the electronic circuit arrangement in the head 2. The following elements are located off the circuit board 57: wall plug 240, transformer 241, power connector 246, batteries 243, on/off switch 244, right laser 50, left laser 51, main level brush 230, left brush 222, left level motor 223, right brush 224, right level motor 225, right light sensor 214, left light sensor 219, computer 3, transmission module 4, transmitter/receiver 204, one cycle interrupter 209, rotation encoder 208, level sensor 233, height motor 252, level opto interrupter 235, height encoder 236 and rotating drive motor 90.

In a preferred embodiment, a high voltage refers to 5 volts. A low voltage refers to 0 volts. Other choices of voltage values are possible. Except where specifically noted, all signals are “sent” by wire(s) which are illustrated as single lines (—) in FIG. 13. Also illustrated in FIG. 13 are busses which are shown as 2 lines with arrows on the ends ( [symbol] ). Busses are multiple wires, which share a common purpose and are connected to the same components. To “send” or to “signal” is when a device places a voltage level on a wire or bus. To “send to” means the device can cause the voltage level on a wire or bus. A “pulse” is a sequence of low voltage—high voltage—low voltage or a sequence of high voltage—low voltage high voltage on a wire.

In the broad aspect of the circuit, there is one power supply system, and three control and measurement systems. The three control and measurement systems are (a) the main control and height system controlled by the main microprocessor 201, (b) the right laser system controlled by the right microprocessor 212, and (c) the left laser system controlled by the left microprocessor 217.

The power supply system plugs into a power outlet by the wall plug 240 which supplies power to the transformer 241. The transformer 241 converts power to a voltage level and at a sufficient current to power the head 2. The wall plug 240 and transformer 241 are outside the head 2 and attaches to the head 2 via the power connector 246. Internal to the head 2 is the power regulator 242 which takes power from the power connector 246 via wires and converts it to a voltage level sufficient to charge the batteries 243. Both the power regulator 242 and batteries 243 are connected by wires to the on/off switch 244 which, when closed, allows power to flow to the voltage supply 245 at the voltage on the batteries 243. The voltage supply 245 converts the voltage on the batteries 243 to +5 volts, −5 volts, +battery volts and −battery volts and supplies these voltages as required to the other circuit components through wires (not shown).

When the on/off switch 244 is closed, the right oscillator 250 and left oscillator 251 provide power and an oscillating signal such that the right laser 50 and left laser 51 emit an oscillating light beam at their unique, respective frequencies. In a preferred embodiment, the right laser 50 is emitting a beam of light pulsing at approximately 6000 Hertz (Hz). The left laser 51 is emitting a beam of light pulsing at approximately 2400 Hertz. It is within the scope of the invention that the beams emitted by the respective lasers have other characteristics which enable them (e.g., their reflections from the targets) to be distinguished from one another, such as their basic underlying frequency (e.g., color).

When the on/off switch 244 is closed, the right microprocessor 212 will run an initialization program which is a sequence of instructions that prepares the circuit for operation. After initialization, the right microprocessor 212 will wait for signals on the 2 line bus 211 which will cause it to perform its program. The communication protocol used is the “Inter-Integrated Circuit” (I2C—pronounced as I squared C), multi-master protocol.

When the on/off switch 244 is closed, the left microprocessor 217 will run an initialization program which is a sequence of instructions that prepares the circuit for operation. After initialization, the left microprocessor 217 will wait for signals on the 2 line bus 211 which will cause it to perform its program.

When the on/off switch 244 is closed, the main microprocessor 201 will run an initialization program which is a sequence of instructions that prepares the circuit for operation. After initialization, the main microprocessor 201 will perform a level the head 2 procedure.

The level the head 2 procedure starts by the main microprocessor 201 performing the parallel the level arm 70 procedure as follows.

The main microprocessor 201 will send a signal to the height motor drive 234 which will cause the height motor 252 to move the level arm 70 down. When the level interrupter plate 71 is inserted between the towers of the level opto interrupter 235, the output will change voltage. When the main microprocessor 201 detects this change of voltage, the main microprocessor 201 will pause and then signal the height motor drive 234 to stop the height motor 252. Next, the main microprocessor 201 will send a signal to the height motor drive 234 which will cause the height motor 252 to move the level arm 70 up. When the level interrupter plate 71 is withdrawn from between the towers of the 235, the output will change voltage. When the main microprocessor 201 detects this change of voltage, the main microprocessor 201 will signal the height motor drive 234 to stop the height motor 252. The level arm 70 is now parallel to the rotating platform 80.

Next, the main microprocessor 201 will send a signal to the rotation motor drive 205 which will cause the rotating drive motor 90 to rotate the rotating platform 80. When the level motor drive 231 senses that the main level brush 230 has made contact with either the left brush 222 or right brush 224, the level motor drive 231 will send a signal to the 201. When the main microprocessor 201 senses this signal, it will cause the rotation motor drive 205 to stop the rotating drive motor 90.

Next, the main microprocessor 201 will send a signal to the level electronics 232 which will sense the resistive value between the pins of the level sensor 233. The level electronics 232 will maintain a voltage on a wire to the main microprocessor 201 which will indicate whether the level is tilted one way or the other.

Next, the main microprocessor 201 will monitor the signal from the level electronics 232. The main microprocessor 201 will send a signal to the level motor drive 231 which will provide power through the main level brush 230 to the left brush 222 or the right brush 224, whichever are in contact with the main level brush 230, to cause the left level motor 223 or the right level motor 225 to move the rotating platform 80 in the direction to be more level. The main microprocessor 201 will monitor the signal from the level electronics 232. When the level electronics 232 signal changes voltage level, the main microprocessor 201 will send a signal to the level motor drive 231 to remove the voltage from the main level brush 230.

The main microprocessor 201 will cause the rotating drive motor 90 to rotate as was done before. When the level motor drive 231 senses that main level brush 230 has made contact with either the left brush 222 or the right brush 224, the level motor drive 231 will send a signal to the main microprocessor 201. When the main microprocessor 201 senses this signal, it will cause the rotation motor drive 205 to stop the rotating drive motor 90. Whichever of the left brush 222 or right brush 224 were contacted before, this will be the other one.

As was done previously, the main microprocessor 201 will monitor the signal from the level electronics 232. The main microprocessor 201 will send a signal to the level motor drive 231 which will provide power through the main level brush 230 to the left brush 222 or the right brush 224, whichever are in contact with the main level brush 230, to cause the left level motor 223 or the right level motor 225 to move the rotating platform 80 in the direction to be more level. The main microprocessor 201 will monitor the signal from the level electronics 232. When the level electronics 232 signal changes voltage level, the main microprocessor 201 will send a signal to the level motor drive 231 to remove the voltage from the main level brush 230.

This process will continue until the rotating platform 80 and therefore the head 2 is level.

After leveling the head 2, the main microprocessor 201 will perform the seek the transmission module 4 procedure as follows.

The main microprocessor 201 will perform the find the start position procedure. The main microprocessor 201 will start the rotating drive motor 90 rotating as was done before. Next, the main microprocessor 201 will monitor the wire from the one cycle interrupter 209. The one cycle interrupter 209 will keep the wire at a high voltage when the rotating interrupter plate 91 is not between the towers of the one cycle interrupter 209. As the rotating drive motor 90 rotates, eventually the rotating interrupter plate 91 will come between the towers of the one cycle interrupter 209. The one cycle interrupter 209 will cause the voltage on the wire to the main microprocessor 201 to go low.

The main microprocessor 201 will next perform the measure circle and reset procedure. As the rotating drive motor 90 continues to rotate, the rotating interrupter plate 91 will exit from between the towers. The one cycle interrupter 209 will cause the voltage on the wire to the main microprocessor 201 to go high. This event will be signaled to the main microprocessor 201, the main parallel to serial converter 206 and the main counter 207.

The measuring of rotational position by the main microprocessor 201 is done by capturing the counts of the rotation encoder 208 when the position measure is required. As power is applied to the rotating drive motor 90, the rotating drive motor 90 causes the rotating platform 80 to rotate. Fixedly attached to the rotating drive motor 90 is the rotation encoder 208. As the rotating drive motor 90 rotates, the rotation encoder 208 sends pulses to the main counter 207. The main counter 207 counts these pulses. The main counter 207 maintains the cumulative count. The main counter 207 will maintain the cumulative count on the 24 line bus 210 by placing a voltage on each wire of the 24 line bus 210. Whenever a measurement of rotational position is required, the main microprocessor 201 will cause the main parallel to serial converter 206 registers to capture the count from the 24 line bus 210 and to be transferred to the main microprocessor 201. Next, the main microprocessor 201 will provide pulses on the 2 line bus 211 in such a pulse pattern as to cause the number which is the counts data to be transferred to the main memory 202 into the predetermined address. Thus, the rotational position is measured.

When the one cycle interrupter 209 sends the signal that the rotating interrupter plate 91 has exited from between the plates, two events will occur in sequential order. The measure the rotational position will be performed and the main counter 207 will reset the count to 0 counts. Thus, the measure circle and reset procedure is accomplished.

Next, the main microprocessor 201 will establish communication with the computer 3 as follows.

When the main microprocessor 201 sends signals via the communications electronics 203 to the computer 3, the main microprocessor 201 will send the appropriate signal to the communications electronics 203 which will send the appropriate pulses to the transmitter/receiver 204. In a preferred embodiment, the transmitter/receiver 204 will pulse an infrared light. Other types of pulses such as laser beam pulses, radio frequency pulses in various frequency bands could be used. If the transmission module 4 is receiving these pulses, the transmission module 4 will convert these pulses to electrical signals and send them to the computer 3.

When the computer 3 sends signals via the transmission module 4, the transmitter/receiver 204 will detect these signals and cause signals to be sent to the communications electronics 203. The communications electronics 203 converts signals from the transmitter/receiver 204 to signals that the main microprocessor 201 can interpret.

After the one cycle interrupter 209 sends the signal that the rotating interrupter plate 91 has exited from between the towers, the main microprocessor 201 will begin alternately send a signal to the computer 3 via the communications electronics 203 and waiting for as acknowledge signal from the computer 3.

If the transmitter/receiver 204 is not properly aligned, the transmission module 4 will not receive a signal and, therefore, the computer 3 will not send an acknowledge signal.

When the transmitter/receiver 204 and transmission module 4 become properly aligned, the computer 3 will send an acknowledge signal. When the main microprocessor 201 receives this acknowledge signal, the communication link between the main microprocessor 201 and transmission module 4 is established.

After the main microprocessor 201 receives the acknowledge signal, the main microprocessor 201 will cause the rotating drive motor 90 to stop and will await instructions from the computer 3. Thus, the establish communications procedure is done.

Next, the “send sample” procedure may be executed.

The send sample procedure begins when the operator chooses this option on the computer 3. The computer 3 will communicate this instruction to the main microprocessor 201 via the communication link as previously discussed.

When the main microprocessor 201 receives the send sample instruction, the main microprocessor 201 will perform the find the start position procedure as was previously described. When the main microprocessor 201 receives the signal that the rotating interrupter plate 91 has exited the rotation encoder 208, the measure circle and reset procedure will be performed as was previously described.

Next, the main microprocessor 201 will pulse the 2 line bus 211. These pulses are communication and instruction of the main microprocessor 201 with the right microprocessor 212 and left microprocessor 217 in turn. When the right microprocessor 212 and left microprocessor 217 detects their respective addresses, each will perform the measure target position procedure as follows.

The measure target procedure is described for the right microprocessor 212, right frequency filter and amplifier 213, right light sensor 214, right laser 50 and right parallel to serial converter 216. The procedure will also apply for the left microprocessor 217, left frequency filter and amplifier 218, left light sensor 219, left laser 51 and left parallel to serial converter 221, respectively.

The measure target procedure begins with the right laser 50. As the laser beam impinges on a surface, some of the light is reflected back to the right light sensor 214 through the optical system as previously discussed. The right light sensor 214 converts the light received to an electrical signal which is the analog of the amount of light received and of the frequency of the light. This electrical signal is sent by wire to the right frequency filter and amplifier 213. The frequency filter part of the right frequency filter and amplifier 213 will attenuate signals that are outside the band of the right laser 50 pulsing frequency at its center. Specifically, it will reject steady electrical signals such as from outside light, 60 Hz light such as from building lighting and light pulsing at frequency of the left laser 51.

Next, if the electrical signal from the right light sensor 214 is low or outside the frequency range of the right laser 50, the right frequency filter and amplifier 213 will place a low voltage on the wire to the right microprocessor 212. if the electrical signal from the right light sensor 214 is high or within the frequency range of the right laser 50, the right frequency filter and amplifier 213 will place a high voltage on the wire to the right microprocessor 212. If the laser beam from the right laser 50 is impinging on a white or reflective surface within a limited distance of the right laser 50, the signal from the right frequency filter and amplifier 213 will be high. If the laser beam from the right laser 50 is impinging on a black or dark surface or farther than a limited distance of the right laser 50, the signal from the right frequency filter and amplifier 213 will be low.

The right microprocessor 212 will next record the location of targets 8.

The initial setting in the right microprocessor 212 will be as if a low or black signal was on the wire from the right frequency filter and amplifier 213. When the right microprocessor 212 detects a low to high or a high to low transitions on the wire from the right frequency filter and amplifier 213, the right microprocessor 212 will send a signal to the right parallel to serial converter 216 to cause the right parallel to serial converter 216 to capture the count on the 24 line bus 210 and then to send the number which represents the count to the right microprocessor 212 similar to how the main microprocessor 201 interfaced with the main parallel to serial converter 206. The right microprocessor 212 will store this number in its memory.

Since the initial condition for the wire from the right frequency filter and amplifier 213 is low, the first transition will be from low to high. The next number of counts recorded by the right microprocessor 212 will be for a high to low transition. If the difference of these numbers is outside a predetermined range, the right microprocessor 212 will delete them from memory. If the difference of these numbers is within a predetermined range, the right microprocessor 212 will pulse the 2 line bus 211 in such pattern as to cause these numbers to be stored in a predetermined address of the main memory 202. The location of one target 8 has now been measured.

The right microprocessor 212 will continue to record other targets 8 encountered.

When the rotating interrupter plate 91 again exits the one cycle interrupter 209, the measure circle and reset procedure is performed as was previously done, the main microprocessor 201 will send an instruction to the right microprocessor 212 and left microprocessor 217 to stop recording the location of target 8. Next, the main microprocessor 201 will begin seeking the computer 3 as was previously done.

After communications are established between the computer 3 and the main microprocessor 201, the main microprocessor 201 will initiate pulses on the 2 line bus 211 to cause the main memory 202 to send the collected data from both the right microprocessor 212 and left microprocessor 217 to the main microprocessor 201. The main microprocessor 201 will then send this data to the computer 3.

Thus, the send sample procedure is completed.

If the signal from the communications electronics 203 instructs the main microprocessor 201 to start measuring, the main microprocessor 201 will perform the measurement procedure as follows.

The main microprocessor 201 will perform the level the head 2 procedure, then perform the find the start position procedure and the measure the circle and reset procedure as previously described. Next, the main microprocessor 201 will send appropriate signals to the 2 line bus 211 which will cause the right microprocessor 212 and the left microprocessor 217 to start the measure target position procedure as previously described. When the rotating interrupter plate 91 passes through the one cycle interrupter 209 again, the main microprocessor 201 will again perform the measure the circle and reset procedure.

The main microprocessor 201 will cause the head 2 to complete a predetermined number of cycles of the measure the circle and reset procedure as previously described followed by the measure target position procedure as previously described. In the present embodiment, 5 such cycles are performed.

Next, the main microprocessor 201 will perform the height angle measurement procedure of a target 8. The main microprocessor 201 will pulse the 2 line bus 211 so as to cause the main memory 202 to return the first or next data set for a target stored during the measure target procedure. The main memory 202 has stored the angular count when each laser right laser 50 or left laser 51 beam first impinged and last impinged on each target. These data are stored in order with each data set being a higher number than the last. Thus, the first target encountered (acquired) by the right laser 50 beam is stored in the first address. The second target encountered by the right laser 50 beam is stored in the second address, and so on. The same applies to the left laser 51. There are a number of sets of such data for each rotation of the head 2.

The main microprocessor 201 will calculate the target position that each right microprocessor 212 and left microprocessor 217 stored. Each set of data comprises a low to high transition count and a high to low count. The main microprocessor 201 will average these two numbers for each cycle of a side stored by the right microprocessor 212 or left microprocessor 217. Then for each target position there are a multiple of cycles for each target. The main microprocessor 201 will ignore the largest and smallest of these numbers and average the others. In a preferred embodiment, there are 5 cycles. The main microprocessor 201 will ignore the largest of the 5 and ignore the smallest of the 5. Then the main microprocessor 201 will average the remaining 3 numbers. This average represents the number count of the main counter 207 when the laser beam from the right laser 50 or left laser 51 was in the center of the target.

The main microprocessor 201 will now have two numbers, one is the count to the center of the target 8 when the beam from the right laser 50 next encountered a target 8, one is the count to the center of the target 8 when the beam from the left laser 51 next encountered a target 8. The main microprocessor 201 will select the smaller of the two.

The main microprocessor 201 will send a signal to the rotation motor drive 205 that will cause the rotation motor drive 205 to cause the rotating drive motor 90 to rotate slower than before. This is done by applying a lower voltage to the rotating drive motor 90 than was done before.

The main microprocessor 201 will next instruct the main parallel to serial converter 206 to capture and send the current count of the main counter 207. The count will be compared to the smaller of the two calculated numbers which represents the counts to the center of the target being sought. If the current count is smaller than the smaller of calculated numbers, the main microprocessor 201 will again instruct the main parallel to serial converter 206 to capture and send the current count of the main counter 207 and compare. If the current count is equal to or greater than the smaller of calculated numbers, the main microprocessor 201 will instruct the rotation motor drive 205 to stop the rotation by removing the voltage to the rotating drive motor 90.

The beam from either the right laser 50 or left laser 51 is now impinging on the target 8. The main microprocessor 201 will pulse the 2 line bus 211 so as to address and instruct the appropriate right microprocessor 212 or left microprocessor 217 to begin monitoring the returning light intensity as was done before and to address the main microprocessor 201 when the light intensity goes from high to low. The right frequency filter and amplifier 213 or left frequency filter and amplifier 218 is now placing a high voltage on the wire to the right microprocessor 212 or left microprocessor 217, respectively.

The main microprocessor 201 will send the appropriate signal to the height motor drive 234 to cause the height motor 252 to move the level arm 70 down. When the level interrupter plate 71 interrupts the light from between the towers of the level opto interrupter 235, the level opto interrupter 235 will change the voltage on the wire to the main microprocessor 201. The main microprocessor 201 will then pause and then send a signal to the height motor drive 234 to cause the height motor 252 to stop.

Next, the main microprocessor 201 will send a signal to the height counter 237 to cause the height counter 237 to reset the count to 0.

Next, the main microprocessor 201 will send the appropriate signal to the height motor drive 234 to cause the height motor 252 to move the level arm 70 up. As the height motor 252 moves the level arm 70, the height encoder 236 sends pulses to the height counter 237 which counts the pulses. The height counter 237 provides the cumulative count to the 16 wire bus 239. When the level interrupter plate 71 emerges from between the towers of the level opto interrupter 235, the level opto interrupter 235 will change the voltage on the wire to the main microprocessor 201. The main microprocessor 201 will then send the appropriate signal to the height parallel to serial converter 238 to capture the current count from the 16 wire bus 239 and transmit the current count to the main microprocessor 201. The main microprocessor 201 will store this number as a beginning number.

Next, when the light from the right laser 50 or left laser 51 is no longer impinging on the target 8, is at the bottom of the target, the signal from the right frequency filter and amplifier 213 or left frequency filter and amplifier 218 to the main microprocessor 201 will transition from high to low. The right microprocessor 212 or left microprocessor 217 will then pulse the 2 line bus 211 so as to address the main microprocessor 201 and send the signal that the above event has occurred.

The main microprocessor 201 will again capture the count of the height parallel to serial converter 238 as before. The main microprocessor 201 will store this number as an ending number.

The main microprocessor 201 will then send a signal to the level opto interrupter 235 to stop the level arm 70.

The main microprocessor 201 will then perform the parallel the level arm 70 procedure as was previously described.

Next, the main microprocessor 201 will subtract the beginning number from ending number and store the result in the predetermined address of the main memory 202 as was described previously.

Next, the main microprocessor 201 will repeat the height angle measurement procedure for each of the target location number sets in the main memory 202. Thus, the height angle measurement is done.

After all data is gathered, the main microprocessor 201 will perform the find the start position and seek the transmission module 4 procedures. The main microprocessor 201 will send a signal to the computer 3 as previously described that will cause the operator to be informed the data gathering is complete.

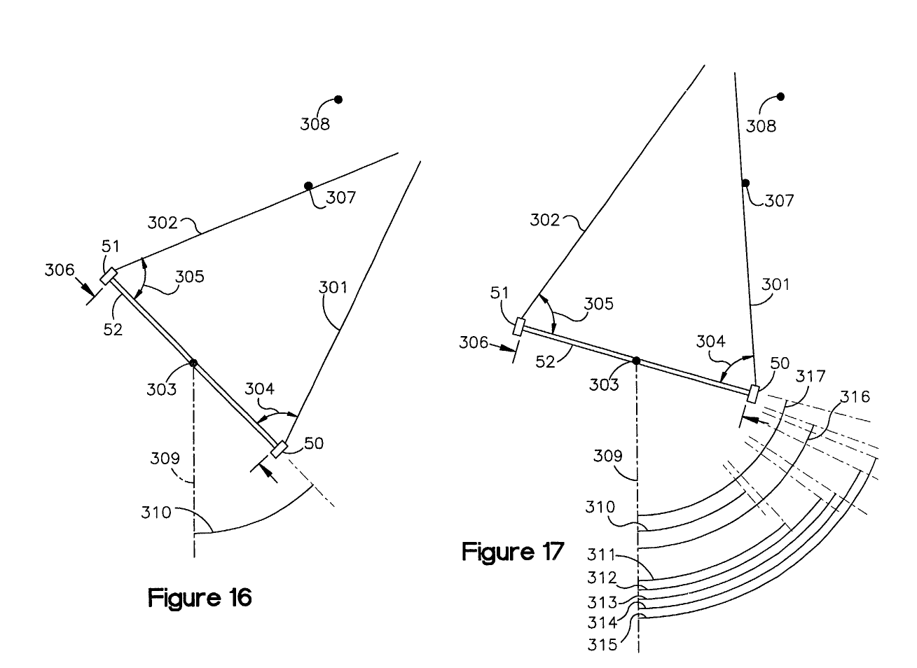

When the operator instructs the computer 3 to get the data, the computer 3 will send a signal to the main microprocessor 201 and the main microprocessor 201 will get the data from the main memory 202 as previously described and transmit the data to the computer 3. Theory of Operation The distance and angle measurements are designated in the following formulas as the number identified in the figures enclosed in brackets. For instance, the measured number for angle first measured angle 310 seen in FIGS. 16 and 17 is [310].

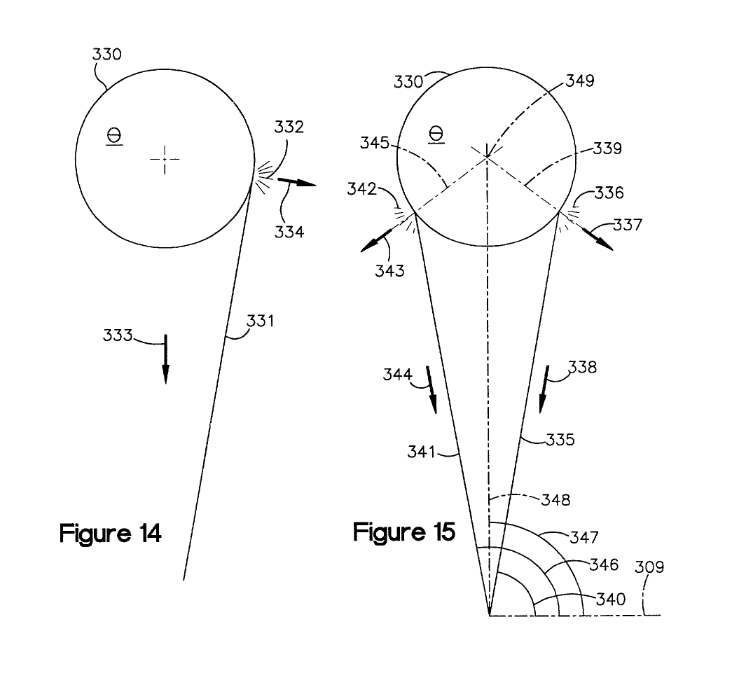

FIG. 14 is a top schematic view of the initial representative beam 331, an outer surface 330 of a target 8 and initial scattered light 332 when the initial representative beam 331 first impinges on a outer surface 330. The majority of the initial scattered light 332 is in the initial major scattering direction 334. Because the outer surface 330 is round, the initial major scattering direction 334 is perpendicular to the outer surface 330 and is at a sufficiently great angle relative to initial sensor direction 333 that little light reaches the right light sensor 214 or left light sensor 219. Therefore, the right frequency filter and amplifier 213 or left frequency filter and amplifier 218 sends a low signal.

As diagrammed in FIG. 15, with more rotation, the first transition angle 340 will be reached wherein the angle between first transition major scattering direction 337 and first transition sensor direction 338 is sufficiently small that enough light from the first transition laser beam 335 reflecting from the outer surface 330 reaches right light sensor 214 or left light sensor 219 that the right frequency filter and amplifier 213 or left frequency filter and amplifier 218 sends a high signal and first transition angle 340 is measured. With more rotation, the similar position is reached on the other side of the target. The angle between the second transition major scattering direction 343 and second transition sensor direction 344 is just large enough so the second transition laser beam 341 reflecting from the outer surface 330 is just weak enough that right light sensor 214 or left light sensor 219 that the right frequency filter and amplifier 213 or left frequency filter and amplifier 218 sends a low signal and the second transition angle 346 is measured. A valid target 8 is a electrical signal sequence from the right frequency filter and amplifier 213 or left frequency filter and amplifier 218 of low, high, low with the difference between the first transition angle 340 and second transition angle 346 being within the target 8 dimensions. If the background to the target 8 is a shiny and reflective area that causes the right frequency filter and amplifier 213 or left frequency filter and amplifier 218 to produce a high signal, the signal will stay high longer that the width of a target 8. Similarly, a flash off reflective material such as the edge of an object is too short. Other possible reflective material such as doors or walls in the background is too far away to have enough light to cause a high signal on the right frequency filter and amplifier 213 or left frequency filter and amplifier 218. It should also be noted that highly reflective material such as a mirror surface will reflect most of the impinging light in a narrow angle and, therefore, will appear to be narrow.

As diagrammed in FIG. 15, first transition major scattering direction 337 and second transition major scattering direction 343 are perpendicular to the surface of outer surface 330. The backward projections first transition projection 339 and second transition projection 345 intersect at the center of target 349. Therefore, the center angle 347 between the center projection 348 and “0” reference 309 is the average of first transition angle 340 and second transition angle 346.

[347]=([346]+[340])/2. (1)

FIG. 16 is a top schematic view of the horizontal and angular relationships of the right laser 50 and left laser 51, laser axle 52, target A 307 and target B 308 when the left laser beam 302 initially detects a target 8. FIG. 17 is an example of the progression of measurements for two targets 8. The horizontal pivot point 303 corresponds to the pivot 62. The position of the right laser 50 and left laser 51 relative to the horizontal pivot point 303 is fixed during manufacture. Also, the left laser angle 305, right laser angle 304 and distance between laser sources 306 are fixed during manufacture.

As the rotating platform 80 rotates, the left laser beam 302 will impinge on target A 307 and will cause the measurement of first measured angle 310 as described previously. As the rotating platform 80 continues to rotate, left laser beam 302 will go off target A 307, left laser beam 302 will initially impinge on target B 308, left laser beam 302 will go off target B 308, right laser beam 301 will initially impinge on target B 308 first, right laser beam 301 will go off target B 308, right laser beam 301 will initially impinge on target A 307 and finally right laser beam 301 will leave target A 307. The angles measured are first measured angle 310, second measured angle 311, third measured angle 312, fourth measured angle 313, fifth angle 314, sixth measured angle 315, seventh measured angle 316 and eighth measured angle 317. Note in this example that the order of right laser beam 301 encountering target B 308 and target A 307 is reversed to the order of left laser beam 302.

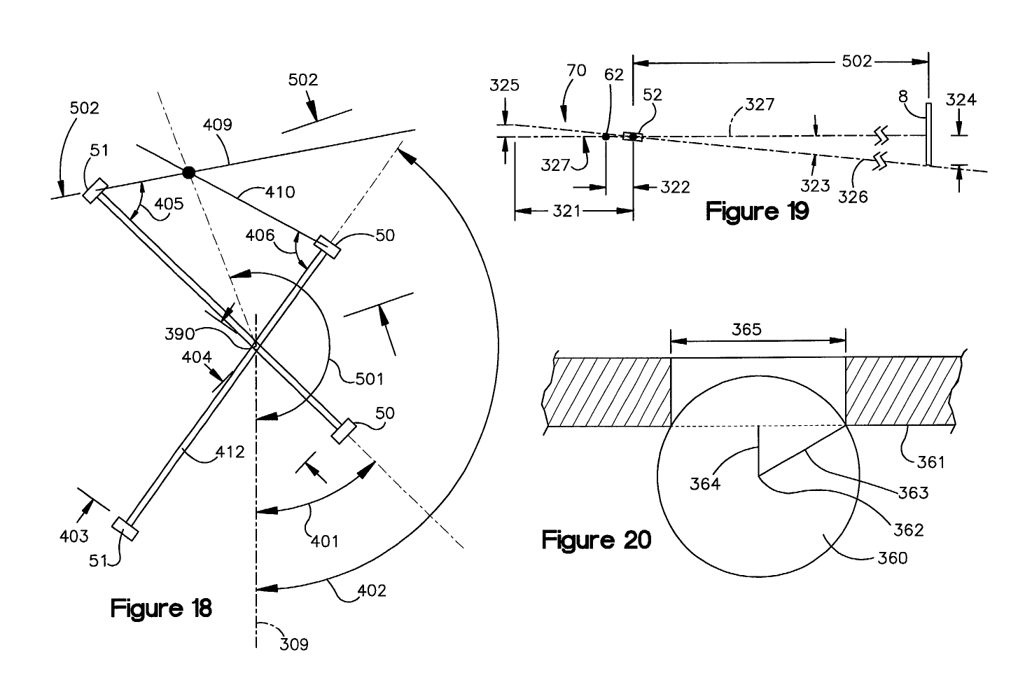

FIG. 18 is a top schematic view of the horizontal and angular relationships of a target 8, the left laser beam 409 from the left laser 51, the right laser beam 410 from the right laser 50 and the axis of horizontal rotation 412. The left distance 403, right distance 404, left laser angle 405 and right laser angle 406, are known and fixed during manufacture. The left angle 401 which is the angle from “0” reference 309 to when the left laser 51 measures the center of target 8 and the right angle 402 which is the angle from “0” reference 309 to when the right laser 50 measures the center of target 8 are measured and calculated according to formula (1). The calculated angle 501 and calculated distance 502 are two of the coordinates in the cylindrical coordinate system needed and are calculated:

K1 is defined as the ratio of degrees of angle of rotation of the base 43 to the pulses of the rotation encoder 208.

[401]=K1× counts calculated by formula (1) for the left laser 51 impinging on target 8.

[402]=K1× counts calculated by formula (1) for the right laser 50 impinging on target 8.

α=[403]sin([405])sin([406]−[402])+[404]sin([406]sin([405]+[401])

β=[403]sin([405])cos([406]−[402]) [404]sin([406]cos([405]+[401])

[501]=arctan (−α/β) (2)

[502]=[403]sin([405])/sin([501]−[405]−[401])

-or-

[502]=[404]sin([406])/sin(180°−[406]−[501]+[402]) (3)

FIG. 19 is a side schematic view of the relationship of the height measurement 325, the level to bottom distance 324 and the 502. The level plane 327 is established during the leveling procedure. Both the target 8 and height screw 72 are plumb to the level plane 327. The beam impinging on lower edge 326 and level arm 70 are made colinear during manufacture. The pivot to axis distance 322 is the perpendicular distance in the horizontal plane between the pivot 62 and laser axle 52. The arm distance 321 is the perpendicular distance in the horizontal plane between the height screw 72 and laser axle 52. The arm distance 321 and pivot to axis distance 322 are set during manufacture. The height measurement 325 which is the distance vertically along the height screw 72 between level plane 327 and the position of the level arm 70 when the beam impinges on lower edge 326 of the target 8. The level to bottom distance 324 is calculated:

K3 is defined as the ratio of distance in the units of measure such as millimeters to the count of pulses from the height encoder 236.

[325]=K3× counts recorded from the height encoder 236 from level to when the beam impinging on lower edge 326.

[324]=[325]×(([502]−[322])/[321]) (4)

FIG. 20 is a left side schematic view of a magnetic attachment device in a hole. The disc magnet symbol 360 is the hanging disc magnet 11 or ground support disc magnet 20. The radius of disc magnet 363 is known and is established during manufacture. The diameter of hole 365 is known by the operator by measurement or by consulting the vehicle-under-test 1 specifications. The height addition 364 is the distance from the center of disc magnet 362 to the bottom of the chassis with hole measurement point 361. It is calculated as:

[364]([363]²−([365]²/4 ))^{0.5} (5)

Computer Functioning

The computer 3 will receive and organize the data received from the head 2, calculate the necessary parameters using the formulas described above, access a data file containing the specification parameters, present the measured and specification parameters on the display in a format that is meaningful to the operator and assist the operator in analyzing the vehicle-under-test 1. Those skilled in the art of computer programming will understand how to write programs to perform the required functions, based on the description set forth herein. Described herein are a number of functions (procedures) performed by the computer 3.

A first procedure is to calibrate the upper measuring fixture 5. The upper measuring fixture 5 may be shipped in pieces and requires assembly at the user's site. The computer's 3 program must allow for a character to identify a particular upper measuring fixture 5 such as an “A”. Next, the following formulas are used to provide the calibration with input of two readings at differing upper fixture bar and pointer 7 heights. The nomenclature convention used is the Hi and H2 represent the first and second height measurement, respectively, which is read from the upper tape measure 37. A parameter with the height designation in braces, the parameter at the indicated height is meant. For example, [DP {H1}] means the parameter DP measurement at height on the upper tape measure 37 of H1.

[DP{H}] is the cylindrical coordinate system distance from the pivot 62 to the point of the upper fixture bar and pointer 7 when the upper tape measure 37 reading is H. During calibration, this is measured. In use this is calculated.

[AP{H}] is the cylindrical coordinate system angle from the “0” reference 309 line to the point of the upper fixture bar and pointer 7 when the upper tape measure 37 reading is H. During calibration, this is measured. In use this is calculated.

[DA{H}]=the angle between the line from rear target 8RE to front target 8FR and the line from rear target 8RE to the point of the upper fixture bar and pointer 7 when the upper tape measure 37 reading is H.

[AFR{H}]=the measured angle to the front target 8FR when the upper tape measure 37 reading is H.

[ARE{H}]=the measured angle to the rear target 8RE when the upper tape measure 37 reading is H.

[DFR{H}]=the measured distance to front target 8FR when the upper tape measure 37 reading is H.

[DRE{H}]=the measured distance to rear target 8RE when the upper tape measure 37 reading is H.

[RP {H}]=the distance from rear target 8RE to the point of the upper fixture bar and pointer 7 when the upper tape measure 37 reading is H.

[DT{H}]=the distance between front target 8FR and rear target 8RE when the upper tape measure 37 reading is H.

[DT{H1}]=([DFR{H1}]²+[DRE{H1}]²−2[DFR{H1}][DRE{H1}]cos([AFR{H1}]−[ARE{H1 }]))^{0.5} (6)

[RP{H1}]=([DRE{H1}]²+[DP{H1}]²−2[DRE{H1}][DP{H1}]cos([ARE{H1 }]−[AP{H1}]))^{0.5} (7)

θ{H1}=arcsin([DFR{H1}]sin([AFR{H1}]−[ARE{H1}])/[DT{H1 }]

λ{H1 }=arcsin([DP{H1}]sin([ARE{H1}]−[AP{H1}])/[RP{H1}]

[DA{H1}]=θ{H1 }+λ{H1} (8)

A similar set of values are measured and calculated for H2.

[DAm] is defined=([DA{H1 }]−[DA{H2}])/([H1]−[H2])

[DAb] is defined=[DA{H1}]−[DAm][H1]

[RPm] is defined=([RP{H1}]−[RP{H2}])/([H1]−[H2])

[RPb] is defined=[RP{H1}]−[RPm][H1]

[DA{H}]=[DAm][H]+[DAb] (9)

[RP{H}]=[RPm][H]+[RPb] (10)

A second procedure is to display an approximate position of all of the targets 8 that the head 2 detected. The purpose of this display is to ensure the head 2 can detect all targets 8. By displaying the approximate position, if one is not detectable, the operator will be able to determine and correct the problem. The computer 3 must initiate the send sample procedure and receive the data generated as previously described. Next, the computer 3 will apply the formulas (1), (2) and (3). Height is not needed. The resulting data points which represent the horizontal position of detected target 8 are displayed.

A third procedure is for the operator to be able to input target configuration data into the computer 3. For a hanging target 8HA, the required data is the hanging rod connector 12 selected and the diameter of hole 365.

CH is defined and the distance in the selected scale units such as millimeters between the bottom of the hanging target 8HA and the center of the hanging disc magnet 11 when the hanging rod connector 12 length is 0.

measured point height=[324]+[364]+CH (11)

for a hanging target

For a ground support target 8GS, the required data is the scale reading on the extendible tube 21 and the diameter of hole 365.

CG is defined and the distance in the selected scale units such as millimeters between the bottom of the ground support target 8GS and the center of the ground support disc magnet 20 when the extendible tube 21 length is 0.

[H] measured point height=[324]+[364]+CG (12)

for a ground support target

For a upper measuring fixture 5, the required data is to match pairs of front target 8FR and rear target 8RE and to input the scale reading of the upper fixture bar and pointer 7 on the upper tape measure 37. The computer 3 will have calibrated parameters of the relative position of the point of the upper fixture bar and pointer 7 from the front target 8FR and rear target 8RE as described previously.

measured point height for a upper fixture=upper tape measure 37 reading of the 7 (13)

[DP{H}]=([DRE{H}]²+[RP{H}]²−2[RP{H}][DRE{H}]cos δ{H})^{0.5} (14)

[AP{H}]=[ARE{H}]−τ{H} (15)

where:

φ{H}=arcsin([DFR{H}]sin([AFR{H}]−[ARE{H}])/[DT{H}])

δ{H}=[DA{H}]−φ{H}

τ{H}=arcsin([RP{H}]sin δ{H}/[DP{H}])

A fourth procedure is to match data from the right laser 50 and left laser 51 by comparing the height measurement. As mentioned previously, the order of the beams impinging on target 8 for the right laser 50 and left laser 51 may be different. As done previously, measurements for height are done for each set of data deriving from each right laser 50 and left laser 51. The computer 3 compares the height data and difference between transitions which is the number of counts the high to low transition minus the number of counts from the low to high transition. The computer 3 then matches the data sets for the angle calculation that have the same height measurement and same difference between transitions within a small error limit.

A fifth procedure is for the operator to select three head 2 measured points and match each to the corresponding specification data. This is to be able to match the measured points with their specification position. Any difference is the error or misalignment of the vehicle-under-test 1.

### Operation

The following is a sequence of steps the operator may use to calibrate a upper measuring fixture 5.

1. Turn on the computer 3 and the head 2.

2. Position the head 2 and transmission module 4 in convenient locations.

3. Position the upper measuring fixture 5 near the head 2 such that the front target 8FR, rear target 8RE and point of the upper fixture bar and pointer 7 are approximately equidistant from the head 2.

4. Place a ground support target 8GS or hanging target 8HA on the point of the pointer 10 with the upper fixture bar and pointer 7 at about 100 millimeters as measured on the upper tape measure 37.

5. Go to the part of the program to calibrate the upper measuring fixture 5.

6. Enter the necessary information.

7. Instruct the head 2 through the computer 3 to obtain calibration data.

8. Ensure that all targets 8 are detected.

9. Instruct the head 2 through the computer 3 to measure and report data.

10. Place a ground support target 8GS or hanging target 8HA on the point of the pointer 10 with the upper fixture bar at about 200 millimeters as measured on the upper tape measure 37.

11. Repeat steps 7 through 9.

The following is a sequence of steps the operator may use to measure a vehicle-under-test 1:

1. Turn on the computer 3 and the head 2.

2. Obtain a printout of the specification of the vehicle-under-test 1.

3. Using the printout, the operator then positions the target 8 on the vehicle-under test 1 while noting the required target information for later entry into the computer 3.

4. Position the head 2 and transmission module 4 in convenient locations.

5. Instruct the head 2 through the computer 3 to obtain sample data.

6. Ensure that all targets 8 are detected.

7. Instruct the head 2 through the computer 3 to begin measuring.

8. On the computer 3, create the work order, input customer data and perform any other administrative tasks.

9. Gather the data from the head 2.

10. Perform the steps 2 through 9 on another vehicle if required.

11. Input the necessary target information.

12. Analyze and save the data and administrative information.

13. turn off the head 2 and computer 3.

14. Plug wall plug 240 into wall power outlet and into power connector 246.

The invention has been illustrated and described in a manner that should be considered as exemplary rather than restrictive in character—it being understood that only preferred embodiments have been shown and described, and that all changes and modifications that come within the spirit of the invention are desired to be protected. Undoubtedly, many other “variations” on the techniques set forth hereinabove will occur to one having ordinary skill in the art to which the present invention most nearly pertains, and such variations are intended to be within the scope of the invention, as disclosed herein.

What is claimed is:

1. A reflective target for a vehicle measuring system, comprising:
an elongated cylindrical element, an outer surface of the cylindrical element being reflective to light.

2. A reflective target, according to claim 1, wherein:
the cylindrical element is a solid rod or a hollow tube.

3. A reflective target, according to claim 2, wherein:
the outer surface of the cylindrical element is painted white.

4. A reflective target, according to claim 2, further comprising:
a plumb line disposed within the hollow tube, for ensuring that the target is vertically plumb.

5. A reflective target, according to claim 1, further comprising:
a plumb line disposed without the cylindrical element, for ensuring that the cylindrical element is vertically plumb.

6. A reflective target, according to claim 1, further comprising:
a disc-shaped magnet for attaching to a measurement point on the vehicle;
a spacer rod extending between the magnet and a top end of the cylindrical element.

7. A reflective target, according to claim 1, further comprising:
a base for supporting the target on the ground;
a support rod extending between the base and a bottom end of the cylindrical element;
an extendible tube extending from the top of the cylindrical element; and
an indicator disposed at a distal end of the extendible tube.

8. A reflective target, according to claim 1, wherein the reflective target is disposed on a measuring fixture comprising:
a base;
one or more bars extending vertically upward from the base;
a pointer extending from the one or more bars, a distal end of which can be disposed adjacent an upper body measurement point.

9. A reflective target, according to claim 8, further comprising:
a second reflective target disposed on the measuring fixture.

10. A reflective target, according to claim 1, wherein the reflective target has a rounded outer surface.

11. A reflective target, according to claim 1, wherein the reflective target is a component of a vehicle measuring system comprising:
a plurality of light-reflective targets for associating with a plurality of measurement points on a vehicle;
a measuring head for measuring locations of the plurality of targets and providing target location data indicative of the target locations; and
a computer for controlling the operation of the measuring head and for analyzing the target location data supplied by the measuring head.

12. A measuring head for determining the locations of targets in a vehicle measuring system, comprising:
a base covered with a housing;
a rotating platform disposed on the base and within the housing;
means for rotating the rotating platform;
a encoder indicating the rotational position of the rotating platform;
two windows in the housing;
two lasers mounted at two positions at a fixed angle on the rotating platform;
two light sensors, each associated with a respective laser;
wherein the two lasers are arranged such that beams from the two lasers pass through respective ones of the two windows and that light reflected from targets will impinge upon a respective one of the two sensors.

13. A measuring head, according to claim 12, wherein:
each of the two lasers emit a light beam having a characteristic which enables a one of the two beams to be distinguished from the other of the two beams.

14. A measuring head, according to claim 12, wherein: each of the two lasers emit a light beam which is pulsed at a unique frequency.

15. A measuring head, according to claim 12, further comprising:
communications electronics for communicating with a transmission module associated with an external computer.

16. A measuring head, according to claim 12, further comprising:
means for tilting the rotating platform and leveling the rotating platform.

17. A measuring head, according to claim 12, wherein the housing is generally in the form of a disc, having a height so that it can fit underneath a vehicle.

18. Method of measuring a plurality of points on a vehicle, comprising:
disposing a plurality of light-reflective targets at a plurality of points on the vehicle;
with a measuring head, directing light beams at the targets and sensing light reflected from the targets;
determining positions of the targets based on the angle of the head when each of the plurality of light beams is reflected from the target; and
with the measuring head, finding a lower edge of each target.

19. Method, according to claim 18, further comprising:
providing a fixture with a pointer for indicating upper body points;
wherein selected ones of the targets are disposed on the fixture.

20. Method, according to claim 19, further comprising:
calibrating the fixture.

21. Method, according to claim 18, wherein:
selected ones of the points are on the exterior of the vehicle, including the upper exterior surfaces of the vehicle.

22. Method, according to claim 18, further comprising:
maintaining the targets plumb.

23. Method, according to claim 22, further comprising:
locating a target by directing collimated light beams from the measuring head at the target and sensing light reflected off the target.

24. Method, according to claim 23, further comprising;
adjusting the elevation of the laser beam to locate an end of the target.

25. Method, according to claim 18, further comprising:
providing the targets with rounded external surfaces.

26. Method of measuring a plurality of points on a vehicle, comprising:
disposing a plurality of light-reflective targets at a plurality of points on the vehicle;
with a measuring head, directing light beams at the targets and sensing light reflected from the targets;
determining positions of the targets based on the angle of the head when each of the plurality of light beams is reflected from the target; and
with the measuring head, sensing a black-white-black pattern from a narrow reflector surface to pick out a target.
